(19) United States
(12) Patent Application Publication
(10) Pub. No.: US 2005/0071148 A1
(43) Pub. Date: Mar. 31, 2005

(54) Chinese word segmentation

(75) Inventors: Chang-Ning Huang, Beijing (CN); Jianfeng Gao, Beijing (CN); Mu Li, Beijing (CN); Ashley X. Chang, Issaquah, WA (US)

Correspondence Address: Todd R. Fronek;Westman, Champlin & Kelly, Suite 1600, 900 Second Avenue South, Minneapolis, MN, 55402-3319, US

(73) Assignee: Microsoft Corporation, Redmond, WA (US)

(21) Appl. No.: 10/662,602

(22) Filed: Sep. 15, 2003

(51) Int. Cl. G06F 17/28

(52) U.S. Cl. 704/4

(57) ABSTRACT

The present invention relates to a corpus for use in training a language model. The corpus includes a plurality of characters and a plurality of morphological tags associated with a plurality of sequences of characters. The plurality of morphological tags indicate a morphological type of an associated sequence of characters and a combination of parts forming a morphological subtype.

### BACKGROUND OF THE INVENTION

The present invention relates generally to the field of natural language processing. More specifically, the present invention relates to word segmentation.

Word segmentation refers to the process of identifying the individual words that make up an expression of language, such as text. Word segmentation is useful for checking spelling and grammar, synthesizing speech from text, and performing natural language parsing and understanding, all of which benefit from an identification of individual words.

Performing word segmentation of English text is rather straightforward, since spaces and punctuation marks generally delimit the individual words in the text. Consider the English sentence in Table 1 below.

TABLE 1
The motion was then tabled - that is, removed
indefinitely from consideration.

By identifying each contiguous sequence of spaces and/or punctuation marks as the end of the word preceding the sequence, the English sentence in Table 1 may be straightforwardly segmented as shown in Table 2 below.

TABLE 2
The motion was then tabled - that is, removed
indefinitely from consideration.

In Chinese text, word boundaries are implicit rather than explicit. Consider the sentence in Table 3 below, meaning “The committee discussed this problem yesterday afternoon in Buenos Aires.”

TABLE 3

[symbol]

[symbol]

[symbol]

[symbol]

[symbol]

[symbol]

[symbol]

[symbol]

[symbol]

[symbol]

Despite the absence of punctuation and spaces from the sentence, a reader of Chinese would recognize the sentence in Table 3 as being comprised of the words separately underlined in Table 4 below.

TABLE 4

[symbol]

[symbol]

[symbol]

[symbol]

[symbol]

[symbol]

[symbol]

[symbol]

[symbol]

[symbol]

Many methods and systems have been devised to provide word segmentation for languages such as Chinese and Japanese. In some systems, models are trained based on a corpus of segmented text. The models describe the likelihood of various segments appearing in a text string and provide an output indicative thereof. Developing a corpus to train the models takes time and expense. In many instances, the quality of the output of an associated word segmentation system depends largely upon the quality of the corpus used to train the model. As a result, a method for evaluating corpora and developing corpora will aide in providing quality word segmentation.

### SUMMARY OF THE INVENTION

The present invention relates to a corpus for use in training a language model. The corpus includes a plurality of characters and a plurality of morphological tags associated with a plurality of sequences of characters. The plurality of morphological tags indicate a morphological type of an associated sequence of characters and a combination of parts forming a morphological subtype.

In another aspect, a computer readable medium having instructions for performing word segmentation is provided. The instructions include receiving an input of unsegmented text and accessing a language model to determine a segmentation of the text. A morphologically derived word is detected in the text and an output indicative of segmented text and an indication of a combination of parts that form the morphologically derived word is provided.

### BRIEF DESCRIPTION OF THE DRAWINGS

FIG. 1 is a block diagram of a general computing environment in which the present invention can be useful.

FIG. 2 is a block diagram of a language processing system.

FIG. 3 is a flow diagram of a method for developing an annotated corpus.

FIG. 4 is a flow diagram for creating a language model and evaluating the performance of the language model.

FIG. 5 is a block diagram of types and subtypes of morphologically derived words.

### DETAILED DESCRIPTION OF ILLUSTRATIVE EMBODIMENTS

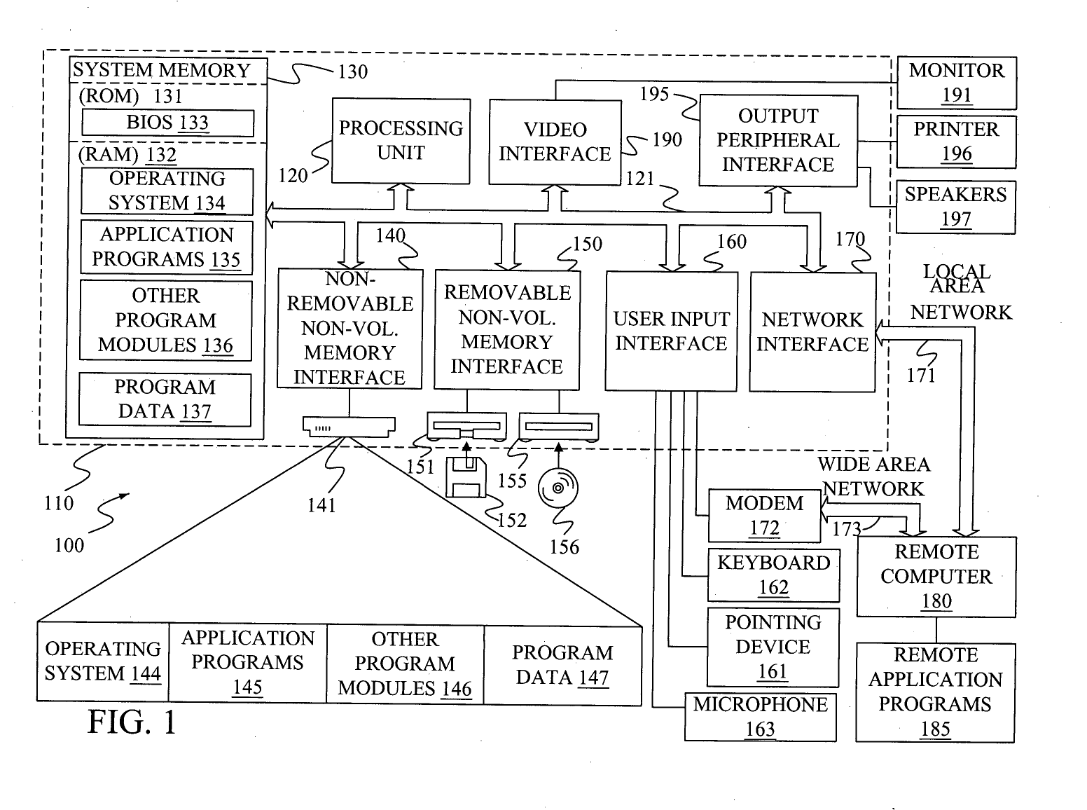

Prior to discussing the present invention in greater detail, an embodiment of an illustrative environment in which the present invention can be used will be discussed. FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

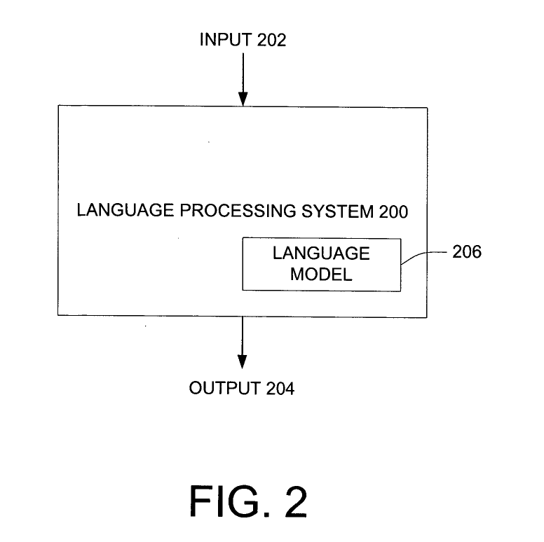

FIG. 2 generally illustrates a language processing system 200 that receives a language input 202 to provide a language output 204. For example, the language processing system 200 can be embodied as a word segmentation system or module that receives as language input 202 unsegmented text. The language processing system 200 processes the unsegmented text and provides an output 204 indicative of segmented text and accompanying information related to the segmented text.

During processing, the language processing system 200 can access a language model 206 in order to determine a segmentation for the input text 202. Language model 206 can be constructed from an annotated corpus that defines various types of words as well as an indication of the specific type. As appreciated by those skilled in the art, language processing system 200 can be useful in various situations such as spell checking, grammar checking, synthesizing speech from text, speech recognition, information retrieval and performing natural language parsing and understanding to name a few. Additionally, language model 206 may be developed based on the particular application for which language processing system 200 is used.

In addition to providing segmentation, system 200 also provides an indication of word type for each of the segmented words. In one embodiment, Chinese words are defined as one of the following four types: (1) entries in a given lexicon (lexicon words or LWs hereafter), (2) morphologically derived words (MDWs), (3) factoids such as Date, Time, Percentage, Money, etc., and (4) named entities (NEs) such as person names (PNs), location names (LNs), and organization names (ONs). Various subtypes can also be defined. Given the definitions of these types of words, system 200 can provide an output indicative of segmentation and word type. For example, consider the unsegmented sentence in Table 5 below, meaning “Friends happily go to Professor Li Junsheng's home for lunch at twelve thirty.”

TABLE 5

[symbol]

[symbol]

[symbol]

[symbol]

[symbol]

[symbol]

[symbol]

[symbol]

[symbol]

[symbol]

[symbol]

[symbol]

[symbol]

An exemplary output of system 200 is shown in Table 6 below. Square brackets indicate word boundaries and a “+” indicates a morpheme boundary. Tags are provided within the brackets to indicate the various types and subtypes of words within the sentence.

TABLE 6
[ [symbol] + [symbol] MA_S] [ [symbol] 12:30 TIME] [ [symbol] [symbol] MR_AABB] [symbol]
[ [symbol] ] [ [symbol] ] [ [symbol] ]

In order to provide segmentation, language model 206 detects word types in the input text 202. For lexicon words, word boundaries are detected if the word is contained in the lexicon. For morphologically derived words, morphological patterns are detected, e.g. [symbol] (which means friend+s) is derived by affixation of the plural affix [symbol] to the noun [symbol] (MA_S is a tag that indicates a suffixation pattern), and [symbol] (which means happily) is a reduplication of [symbol] (happy) (MR_AABB is a tag that indicates an AABB reduplication pattern).

In the case of factoids, their types and normalized forms are detected, e.g. 12:30 is the normalized form of the time expression [symbol] (TIME is a tag that indicates a time expression). For named entities, subtypes are detected, e.g. [symbol] (Li Junsheng) is a person name (PN is a tag that indicates a person name).

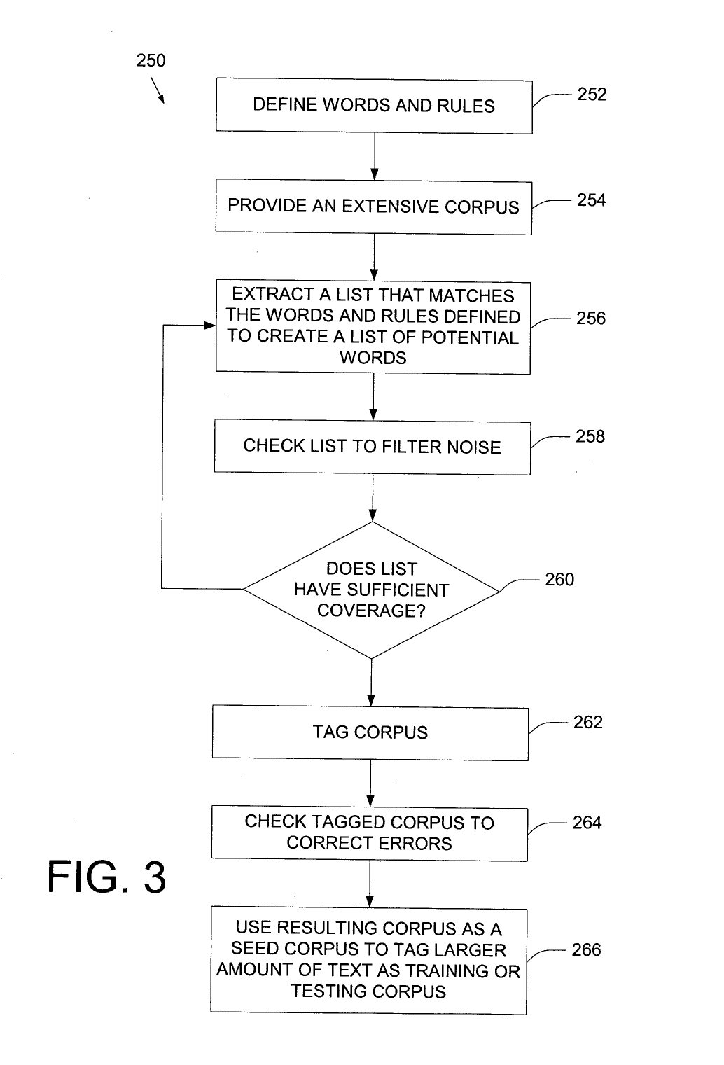

Language model 206 can be created from an annotated corpus. FIG. 3 illustrates a method 250 for developing an annotated corpus that is to be used for creating language models for word segmentation systems, such as language model 206 of system 200. At step 252, words and rules pertaining to word segmentation are defined. For example, a lexicon for Chinese word segmentation, a rule set for Chinese morphologically derived words, a guideline of Chinese factoids and named entities and/or combinations thereof may be defined for developing the annotated corpus. At step 254, an extensive corpus is provided that includes a large amount of text as well as a large variety of text. The extensive corpus may be chosen from various text sources such as newspapers and magazines. Next, at step 256, a list that matches the words and rules defined in step 252 is extracted from the extensive corpus to create a list of potential words.

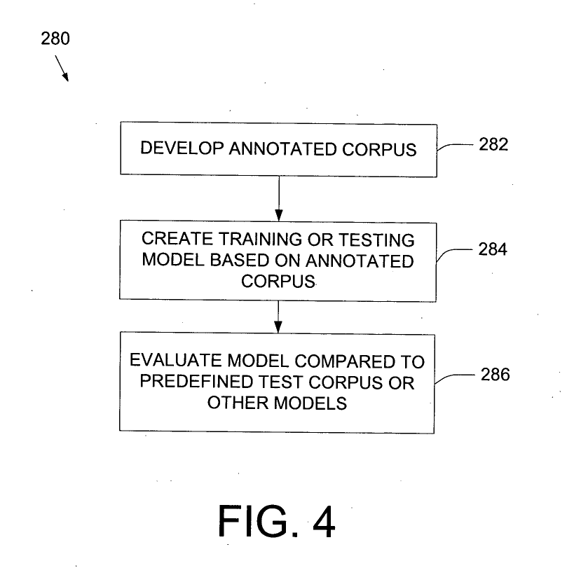

At step 258, the extracted list can be manually checked if desired to filter out any noise or errors within the list. It is then determined whether the list has sufficient coverage of the defined words and rules at step 260. In one embodiment, the list may be compared to a balanced, independent test corpus having a wide variety of domains and styles. For example, the domains and styles may include text related to culture, economy, literature, military, politics, science and technology, society, sports, computers and law to name a few. Alternatively an application specific corpus may be used having broad coverage of a particular application. If it is determined that the list has sufficient coverage, the corpus is then tagged at step 262. The tagging of the corpus can be performed as discussed below. At step 264, the tagged corpus can be checked and any errors may be corrected. At step 266, the resulting corpus is used as a seed corpus to tag a larger amount of text as a training or testing corpus. As a result, an annotated corpus is developed that can be evaluated using method 280 in FIG. 4.

FIG. 4 illustrates a method 280 for creating and evaluating a language model 206 in order to provide improved word segmentation. At step 282, an annotated corpus is developed, the process of which is described above with respect to FIG. 3. Given the annotated corpus, a training or testing model is created based on the annotated corpus at step 284. At step 286, the model created is evaluated by comparing the model to a predefined test corpus or other models. Given the evaluation performed in step 286, the effectiveness of language model 206 can be determined.

In order to evaluate a language model, the output of a word segmentation system using the model can be compared to a standard annotated testing corpus that serves as a standard output of a segmentation system. To achieve a reliable evaluation, a raw (unannotated) test corpus may be chosen that is independent, balanced and of appropriate size. An independent test corpus will have a relatively small overlap with the annotated corpus used to train the language model. A balanced corpus contains documents having wide variety of domain, style and time. In order to be large enough, one embodiment of a test corpus includes approximately one million Chinese characters. After developing the test corpus, the corpus is manually annotated to be used as a standard output of a Chinese word segmentation system given the test corpus. The test corpus can be annotated using the tagging specification described below or another tagging specification.

Given the annotated test corpus, a quantitative evaluation can be used to evaluate the performance of a language model. If the total number of word tokens in the standard test set is “S”, the total number of word tokens of the output of a word segmentation system to be evaluated applied to the test set is “E” and a number of word tokens in the output which exactly matched the word tokens in the standard test set is “M”, quantitative values can be calculated to evaluate performance of the language model. Equations 1-3 below show values for precision, recall and an F-score.
Precision=M/E (1)
Recall=M/S (2)
F=2×Precision×Recall/(Precision+Recall) (3)

Furthermore, the evaluation may be performed on various subtypes according to equations 1-3 above. For example, a person name performance evaluation may be conducted where S_{PN} is the total number of person name tokens in the standard test corpus. E_{PN} is the total number of person name tokens in the output of a word segmentation system to be evaluated and M_{PN} is a the number of person name tokens in the output which exactly matched the person names in the standard test set. As a result, the performance equations are:
Precision_{PN}=M_{PN}/E_{PN} (4)
Recall_{PN}=M_{PN}/S_{PN} (5)
F_{PN}=2×Precision_{PN}×Recall_{PN}/(Precision_{PN}+Recall_{PN}) (6)

It is further useful to compare other system results in evaluating performance of language models. For example, it may be useful to only compare various portions of outputs of different word segmentation systems such as (1) person names, (2) location names, (3) organization names, (4) overlapping ambiguous strings and (5) covering ambiguous strings. By only evaluating a subset of the output of the segmentation systems, a better idea of where errors are occurring in segmentation can result.

In order to develop annotated corpora, a tagging specification is used to consistently tag the corpora given the definitions of Chinese word types described above. Lexicon words with the lexicon are delimited by brackets without additional tagging. Other types are tagged as provided below.

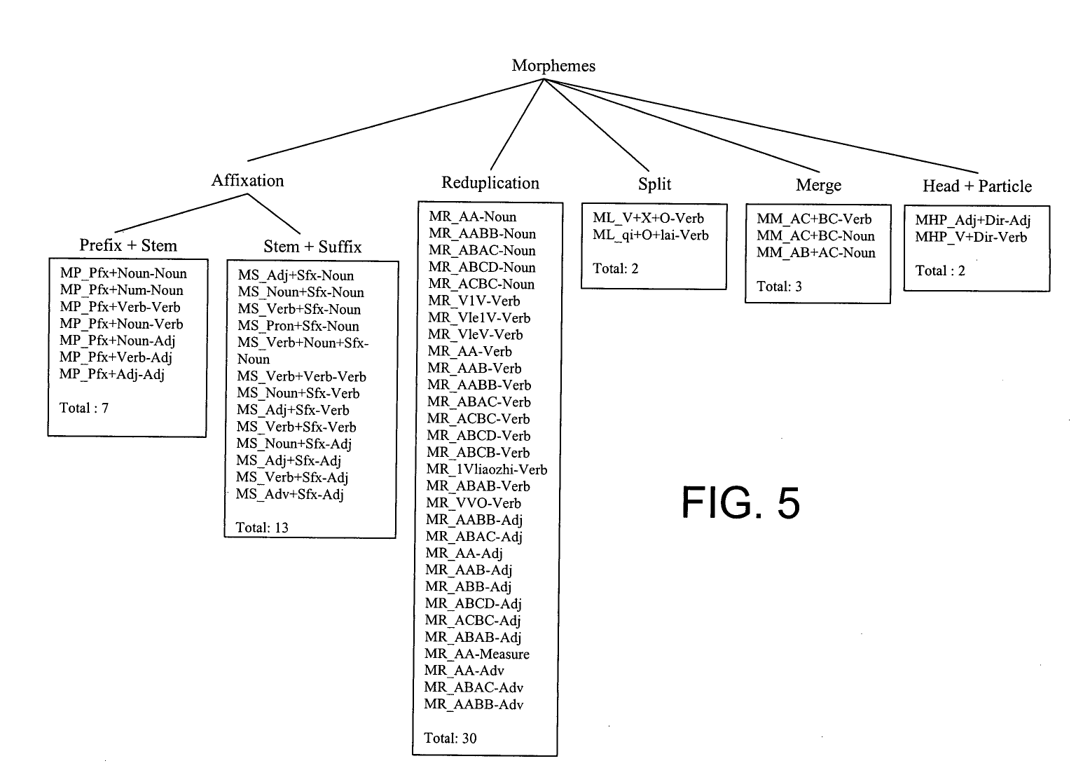

FIG. 5 illustrates a diagram of morphological categories for tagging corpora. The morphological categories include affixation, reduplication, split, merge and head particle. Each morphological category or type includes various subtypes that can be tagged during the tagging process. The format in FIG. 5 shows the category, the parts that make the word and the resultant part of speech of the word. In the diagram of FIG. 5, “MP” stands for morphological prefix and “MS” stands for morphological suffix. “MR” is a reduplication, “ML” a split, “MM” denotes a merge and “MHP” is a morphological head particle. The part between the underscore (_) and the (−) is the combination of parts that form the morphologically derived word. For reduplication and merge, the characters A, B and C represent Chinese characters.

The format in FIG. 5 represents morphological variations and it will be appreciated that other formats of tagging may be used to represent the variations. Affixation includes subcategories prefix and suffix where a character is added to a string of other characters to morphologically change the word represented by the original character. Prefixes includes seven subtypes and suffixes include thirteen subtypes. Reduplication occurs where the original word that consists of a pattern of characters is converted into another word consisting of a combination of characters and includes thirty different subtypes. Reduplication also includes a “V”, which represents a verb, “0” is an object and “1”, “le” and “liaozhi” are particles.

Split includes a set of expressions that are separate words at the syntactic level but single words at the semantic level. For example, a character string ABC may represent the phrase “already ate”, where the bi-character word AC represents the word “ate” and is split by the particle character B representing the word “already”. Split includes two subtypes. One subtype involves inserting a character or characters between a verb and an object and the other inserts an object between the phrase “qilai”. Merging occurs where one word consisting of two characters and another word consisting of two characters are combined to form a single word and includes three subtypes. A head particle occurs when combining a verb character with other characters to form a word and includes two subtypes that combine an adjective and a direction and a verb and a direction.

The tagging format for named entities and factoids is presented in Table 7 below. Format-1 includes simple tags for various types and subtypes to help facilitate quick and easy tagging by a human. For example, the name entities for person, location and organization are simply tagged as P, L and O, respectively. Format-2 represents tagging using the Standardized General Mark-up Language (SGML) according to the Second Multilingual Entity Task Evaluation (MET-2). If desired, a transformation between format-1 and format-2 can be realized through a suitable transformation program.

TABLE 7

| Main | | Format-1 | Format-2 |
|---|---|---|---|
| Category | Subcategory | tagging set | tagging set |
| PERSON | PERSON | P | PERSON |
| LOCATION | LOCATION | L | LOCATION |
| ORGANI- | ORGANIZARION | O | ORGANIZATION |
| ZATION | | | |
| TIMEX | Date | dat | DATE |
| | Duration | dur | DURATION |
| | Time | tim | TIME |
| NUMEX | Percent | per | PERCENT |
| | Money | mon | MONEY |
| | Frequency | fre | FREQUENCY |
| | Integer | int | INTEGER |
| | Fraction | fra | FRACTION |
| | Decimal | dec | DECIMAL |
| | Ordinal | ord | ORDINAL |
| | Rate | rat | RATE |
| MEASUREX | Age | age | AGE |
| | Weight | wei | WEIGHT |
| | Length | len | LENGTH |
| | Temperature | tem | TEMPERATURE |
| | Angle | ang | ANGLE |
| | Area | are | AREA |
| | Capacity | cap | CAPACITY |
| | Speed | spe | SPEED |
| | Other | mea | MEASURE |
| | measures | | |
| ADDRESSX | Email | ema | EMAIL |
| | Phone | pho | PHONE |
| | Fax | fax | FAX |
| | Telex | tel | TELEX |
| | WWW | www | WWW |

Given the tagging format in Table 7, named entities and factoids within corpora can be easily tagged to provide annotated corpora. An example of tagging in format-1 and format-2 is provided below.

Tag in Format-1:

e.g.: on the morning of October 9^{th}--→on the [tim morning] of [dat October 9^{th}]
   The Tagging Format of Format-2:
e.g.: on the morning of October 9^{th}--→on the <TIMEX TYPE=TIME>morning </TIMEX> of <TIMEX TYPE=DATE> October 9^{th} </TIMEX>

It is useful to provide general guidelines when tagging corpora to insure consistency and accuracy. The following description provides these guidelines.

### General Guidelines

(1) Placing an “Enter” in original (raw) text to make a new line should be avoided.
(2) A tagging that is marked as “-ms” is described below. An example is [P-ms [symbol] “Deng Xiaoping theory”.
(3) A string is allowed to have multi-tagging. If the annotators do not have enough information to decide the mono-tagging for such strings, then “I” is introduced for a muti-tagging.
   [L/O [symbol]
(4) OPT: In the case that the annotators are not sure whether some strings are to be tagged or not, then the mark OPT is introduced to mean that this tagging is open to discuss.
   [P/OPT

[symbol]

### Guidelines that Pertain to All Named Entities (Person, Location, Organization)

1. Proper Nouns are those NEs with objective and specific meanings, while the NEs with abstractive and general meanings are not included.

Eg: The expressions, [symbol] Foreigner’, [symbol] girl’ are not Proper Nouns.

2. For a complex Proper Noun, embedded tagging is not allowed. That is to say the maximum matching approach is used where the segmented word having the greatest number of characters is used.

3. TIMES, NUMEX, MEASUREX and ADDRESS that are embedded in Person Name, Location Name and Organization Name are not to be tagged.

[symbol] —right tag
[symbol] [int [symbol] —Wrong tag
   4. In the case that an Entity expression contains some strings in both English and Chinese while the English strings are integrally associated with the Entity, then the whole expression is tagged as an Entity.
[O IBM [symbol]
[O Americant [symbol]
   5. In a possessive construction, the possessor and possessed NE substrings should be tagged separately. In Chinese spelling way, the designator “F” is a sign for such possessive construction.
[L [symbol]
[L [symbol] [symbol] [symbol]
   Note that: the string [symbol] should be considered as part of the Entity if it does not function as the designator.
[O [symbol]
   6. Quotation Marks are included in the tag if they appear within an Entity's name but not if they bound the Entity's name. In Chinese text, Title Marks are treated in the same way.
[O [symbol] [symbol]
<<[O [symbol] [symbol]
   7. Non-decomposable complex phrase. If a complex expression is not an entity as a whole while it contains an entity within the expression, then the entity within the expression is to be tagged as ‘P-ms’, ‘L-ms’, or ‘O-ms’.

If the annotators are not sure whether the expression is decomposable or not, then the expression is treated as decomposable, and the Entity within it is to be tagged. E.g. [L_ms [symbol] “Hong Kong Foot”, with the same meaning as athlete's foot. The expression as a whole is non-decomposable. According to the guideline, the word ‘Hong Kong’ can be tagged as a Location name, ‘L_ms’. E.g. [ord [symbol] [symbol] [symbol] “Forty-sixth Pacific Asia travel Association annual meeting”, in the guideline the expression is treated as decomposable:

[symbol] Pacific Asia travel Association’ is tagged as organization, while [symbol] [symbol] Pacific Asia travel Association annual meeting’ is not an organization.

For an expression ‘Person Name+thought (or: theory, law, ideology)’, the whole expression is to be tagged as ‘p-ms’
[P_ms [symbol] “Marx ideology”
[P_ms [symbol] “Mao Zedong thought”
[P_ms [symbol] “Avogadro's law”
   8. Treatment of [symbol] ( . . . army/ . . . military . . . ). The main distinction is between interpreting [symbol] as an adjective, similar to the English ‘military’ (i.e. ‘not civilian’) and interpreting [symbol] as an ‘organization designator’. In order to get the latter interpretation, look for case in which [symbol] is preceded by a service ‘branch’ designator (such as [symbol] air’ as in ‘Air Force’)
[symbol] “U.S. military aircraft”
[symbol] “SRI Lanka air force”

In general, do not tag terms ending in [symbol] “force” as ORGANIZATION. [L [symbol] “West Africa peacekeeping force”, [symbol] “military base” is to be tagged as LOCATION, NOT ORGANIZATION. [ [symbol] [symbol] “Peterson air military base”

9. For a Name Entity (Person name, Location name, Organization name), if it is a kind of multimedia (TV & Radio shows, movies and books), product or treaty, it is to be tagged with the “-ms” tag.

[P-ms [symbol] “Deng Xiaoping (CL-for-film)'s release, i.e. the release of the film “Deng Xiaoping”

Since [symbol] Ding Xiao Ping’ is the title of a TV program. According to the guideline, ‘Ding Xiao Ping’ is to be tagged as ‘P-ms’.
[L_ms [symbol] (([L_ms [symbol] [symbol]
   10. Aliases, Nicknames, Acronyms of Entity are to be tagged.
[O ETS]
“[O [symbol]
[O IBM]
[L [symbol]
[O

[symbol]

If a Name Entity is embedded in Acronym of Entity, then it is not to be tagged. [O [symbol] , [symbol] means [symbol] no mark up for

[symbol]

### Guideline that Pertain Only to Person

1. Titles of Person

Titles and role names are not considered part of a person's name.
[P [symbol] [symbol] “Albright state minister”
[L [symbol] [symbol] “Queen Elizabeth of England”

However, generational designators [symbol] , [symbol] are considered part of a person's name.
[P [symbol] [symbol] ] “fourteenth dalai tenzin gyatso”
[ [symbol] [P [symbol] “England's queen Elizabeth II”

When a person's title falls between the surname and the given name, include the title.
[P [symbol] “Li Chairman Deng-hui Mister”
   2. Family names are to be tagged as Person
[P [symbol] “the Jiang family, father and son”
[P [symbol] “the Xidi brothers”
   3. Names of animals are to be tagged as Person.
   4. Saints and other religious figures, the proper names are to be tagged as Person.
[P [symbol]
[P [symbol]
   5. Fictional characters are to be tagged as Person.
   6. Fictional animals and non-human characters are to be tagged as Person.
   7. When a person's title or dynasty title refers to a specific person, then it is tagged as Person.
[P [symbol] “Kang Xi, i.e. Emperor Kang Xi”
[P [symbol] “Qin dynasty first emperor”
[P [symbol] “Laozi”
   8. Miscellaneous Personal Non-taggables

If people names appear as the titles of multimedia (TV and radio show, movies and books), of products and of treaties, the names are to be tagged as ‘p_ms’.

<<[P_ms [symbol] “Mona Lisa”, as the title of a painting (or title of a book), is to be tagged “P_ms”.

In the following five cases, the proper names are not to be tagged as Person: laws named after people, courts cases named after people, weather formations named, diseases/prizes named after people.
—no tag on
[symbol] —no tag on [symbol]
[symbol] [symbol] —no tag on [symbol]
[P_ms [symbol] —tag [symbol] Nobel’ as ‘P_ms’
   9. Normal Pattern of Chinese Names

Generally, person Name is constitute of two parts: Family Name (FN) & Given Name (GN)

| # | Name Pattern | How to tag | Example |
|---|---|---|---|
| 1 | Family Name only | Tag FN | [P [symbol] ] |
| | (FN) | | |
| 2 | Given Name only | Tag GN | [P [symbol] ] |
| | (GN) | | |
| 3 | FN+ GN | Tag the whole | [P [symbol] ] |
| | | name | |
| 4 | a. Name (whole | Tag name(s) | [P [symbol] ] [symbol] |
| | name, or GN only, | only, i.e. no | [P [symbol] ] [symbol] |
| | or FN only) + Title | mark on title | [P [symbol] ] [symbol] |
| | b. Title + Name | | [ [symbol] ] [symbol] |
| | | | Title includes: |
| | | | president, |
| | | | premier, |
| | | | minister, |
| | | | principal, |
| | | | professor, |
| | | | teacher, PhD., |
| | | | researcher, |
| | | | senior engineer, |
| | | | chairman, CEO, |
| | | | etc. |
| 5 | Prefix + Name | Tag Name only | [symbol] [P [symbol] ] |
| | Name + Suffix | | [P [symbol] ] [symbol] |
| 6 | Name + Name | Tag the names | [P [symbol] [symbol] [symbol] ] |
| | | separately | [P [symbol] [symbol] [symbol] ] |
| 7 | Foreign name | Tag the whole | [P [symbol] ] |
| | | name | [P [symbol] . [symbol] ] - If |
| | | | the character ‘.’ |
| | | | appears among a |
| | | | Person Name, the |
| | | | name is |
| | | | considered as a |
| | | | whole Entity |

### Guideline that Pertain Only to Location

The strings that are tagged as LOCATION include: oceans, continents, countries, provinces, counties, cities, regions, streets, villages, towns, airports, military bases, roads, railways, bridges, rivers, seas, channels, sounds, bays, straights, sand beach, lakes, parks, mountains, plains, meadows, mines, exhibition centers, etc., fictional or mythical locations, and certain structure, such as the Eiffel Tower and Lincoln Monument.
[L [symbol] L [symbol] 9] t[L [symbol] 49 [symbol] “Beijing City, Haidian district, Zhichun road No.49”

[L [symbol] “Korea south and north dialogue”, tag on Korea but no tag on south/north” [symbol] (L [symbol] “conflict between Arab and Israel”, tag on Israel but no tag on Arab since it does not refer to a specific country
[symbol] “former Yugoslavia area”

[symbol]

[symbol]

[symbol]

[symbol]

“epicenter located at north 36.0 degrees east 95.9 degrees”.

1. For Location entity embedded in another Location Entity, then the whole entity is to be tagged.

[L [symbol] ” America military base”, no tag on America Treatment of [symbol] “ . . . district/ . . . area”. If [symbol] means a specific district, then it is to be tagged as part of the Location; if [symbol] generally means some area, then it is not to be tagged; if the point of [symbol] is unclear, then it is not tagged. [L [symbol] [symbol] [L [symbol] “Lin Yi district now changes it name into Lin Yi city” For Organization names embedded in location names, the organization name are not be tagged. [L [symbol] “White House rose garden”, no tag on White House.
   2. Locative Designators are to be Tagged as Part of Location.
[L [symbol] “Maryland state”
[L [symbol] “Jordan River”

Compound expressions in which place names are listed in succession are to be tagged as separate instances of Location. [L [symbol] [L [symbol] [symbol] [L [symbol] “Jilin province Yanbian Korean autonomous region Tumen municipality”.

3. Transnational Locative Entity Expressions

[L [symbol] “west Africa country leader” [L [symbol] “Asia & Pacific Rim”, tagged as one entity [L [symbol] “western hemisphere countries” [symbol] No mark up.

Subnational region names:
[L [symbol] “South China”
[L [symbol] “Northwest five provinces”
[symbol] “causing the southwest region's passenger service . . . ”, no markup on “southwest” since it has no fixed reference [L [symbol] “South China region”, here South China has fixed reference.
   4. Time modifiers of locative Entity Expressions. Historic-time modifies (“former”) are not to be included in tagged expressions. [symbol] “the former Yugoslavia region”
   5. Space Modifiers of Locative Entity Expressions
[L [symbol] “North Ireland”
[L [symbol] “central Siberia”
[L [symbol] “central and south America”, this expressions contain two Location entities “central America” and “south America”, so they are to be tagged separately.’
   6. Miscellaneous Locative Non-Taggables:
   Do not tag the names of locations which are in language names of the form x- [symbol] or x [symbol] where x is a location.
[symbol] “England language, i.e. English”, no tag on
[symbol] “China language”, no tag on

[symbol]

Do tag the location names of the form x-it, where x is a location. [symbol] “using Sichuan words”, tag on Location on

[symbol]

7. Do not tag location names which are part of the names, ending in [symbol] or [symbol] of ethnic groups.

[symbol] [L [symbol] [symbol]
“the intent was to promote peace and understanding between Cyprus Greece-ethnic-group and turkey-ethnic-group”.

In the expressions [symbol] and [symbol] are not to be tagged as Location. However, in the expressions
[symbol] [symbol] [symbol] and [symbol] are to be tagged as Location.

8. Normal Pattern of Location

| | | | |
|---|---|---|---|
| | Location | | |
| # | pattern | How to tag | Example |

| | | | |
|---|---|---|---|
| 1 | Location Name | Tag LN | [L [symbol] ] |
| | only (LN) | | |
| 2 | LN+ Location | Tag the whole | [L [symbol] ] |
| | Designator | expression | [L [symbol] ] |
| 3 | Compound | Tag separately | [L [symbol] ] |
| | expressions in | | [L [symbol] ] |
| | which place | | [L [symbol] ]; |
| | names are | | [L [symbol] ], |
| | listed in | | [L [symbol] ], |
| | succession | | [L [symbol] ] |
| 4 | Alias or | Tag separately | [L [symbol] ], |
| | nicknames are | | [L [symbol] ], [L [symbol] ]; |
| | listed in | | [L [symbol] ] [L [symbol] ] |
| | succession | | [L [symbol] ] [symbol] ; |
| | | | [L [symbol] ] [L [symbol] ] |
| | | | [symbol] |
| | | | [symbol] |
| 5. | LN expression | NO tag for the | [L [symbol] ] |
| | contains person | person name or | [L [symbol] ] |
| | name or place | the place name | |
| | name | | |
| 6 | LN + L | Tag the | [L [symbol] ] |
| | designator, as | expression | [L [symbol] ] |
| | a whole to | using maximum | |
| | express a | matching | |
| | complete | approach | |
| | concept | | |

### Guideline that Pertain Only to Organization

Proper names that are to be tagged as Organization include stock exchanges, multinational organizations, businesses, TV or radio stations, political parties, religious groups, orchestras, bands, or musical groups, unions, non-generic governmental entity names such as “congress”, or “chamber of deputies,” sports teams and armies ( unless designated only by country names, which are tagged as Location), as well as fictional organizations.

Corporate or organization designators are considered part of an organization name. A basic principle for Location tagging is to use maximum matching approach.
[symbol] [symbol] [P [symbol]
“former China Xinhua News Hang Kong branch director Xu Jiatun”
[symbol] [symbol] [symbol] “Peking University Computing Science Department Artificial intelligence Lab”

Normal Pattern for Organization

| # | Type | Tag | Example |
|---|---|---|---|
| 1 | organization name + designator | Tag as a | [O [symbol] ] |
| | | whole | |
| 2 | place | Tag as a | [O [symbol] ] |
| | name + organization | whole | |
| | name | | |
| 3 | Person name + Organization | Tag as a | [O [symbol] ] |
| | name | whole | |
| 4 | Alias or abbreviation | Tag as a | [O [symbol] ] |
| | | whole | |

1. National (or international) legislative bodies and departments or ministries are to be tagged as Organization. [symbol]
[symbol] [dat [symbol] [symbol] [symbol] [symbol]
[P [symbol] [symbol]
   2. Treatment of Location name immediately preceding an organization name. Generally there are two types of relations between the Location and the Organization: one is procession (such as [symbol] “France aviation and space flight bureau”), the other is the geography link (such as [symbol] “Beijing University”).’
   2.1 For an Organization Entity beginning with a location name, if removing Location is to lead to a location without specific referring, then the Location name is to be tagged as part of Organization.
[symbol] “Beijing University”
[symbol] “Shenzhen middle school”
   2.2 For the Organization expression mentioned above, if there is one location name (or more than one names) immediately preceding it, then the location name and the Organization expression are to be tagged separately.
[L [symbol] “China Beijing University”
[L [symbol] [L [symbol] “China Guangdong Province Shenzhen middle school”
   2.3 For an Organization Entity beginning with non-location string (such as [symbol] “Tongji University”), if there is one Location (or more than one locations) preceding it, then only the Location immediately preceding it is to be tagged as part of Organization.
[symbol] “Shanghai Tongji University”
[L [symbol] [symbol] “China Shanghai Tongji University”
[symbol] “Hubei province WuGang No. 3 middle school”
   2.4 If an Organization Entity begins with two or more paratactic locations, then all those locations are to be tagged as part of Organization; if there is other location(s) receding the whole Organization, then the location and organization are to be tagged separately.
[L [symbol] [symbol] “Los Angeles Asia Pacific laws center”
[L [symbol] [symbol] “Hong Kong, China, Hong Kong Commercial Association”
   2.5 For some complex case, it is unclear whether Organization begins with one location or two, then tagging should be made according to rule 2.1 ‘and 2.2.
E.g.: [symbol] [symbol] “Los Angeles Taipei Economics & Culture Office”, whether tag as A: [L

[symbol]

[symbol]

[symbol]

[symbol]

In this case, tagging A is chosen by default.

2.6 In the case that annotators do not have enough knowledge to decide whether organization begins with a location.

E.g.: in the expression “ [symbol] [symbol] [symbol] annotators are not sure whether [symbol] is a location name. However, it is clear that once this string is removed, the left strings have no specific referring. Therefore, according to 2.1, the expression is to be tagged as:

[L [symbol] [symbol] [symbol]
   2.7 If a location entity immediately follows by an Organization, while there is no modifying relation existing between them, then they are to be tagged separately.
[symbol] [L [symbol] “have promoted the cooperation between China and Southeast Asia”
[symbol] [L [symbol] [symbol] “on Geneva UN human rights conference”
   3. Phrases ending with “ . . . [symbol] ” (meeting, conference, arts festival, athletic competitions) refer to events, and are not to be tagged as Organization. However, the institutional structures themselves—steering committees, etc.—should be tagged as ORGANIZATION.
[symbol] “Olympic sports meeting”
[symbol] “Olympic Committee”

If the phrases “ . . . [symbol] ” refer to “Congress” or “Chamber of deputies”, then they are to be tagged as Organization. Notice that session meetings of Congress (or Chamber of deputies) are not be tagged as Organization, because they are events. [symbol] [symbol] [symbol] [symbol] [symbol] [symbol]
[symbol] 4. If the first person pronouns [symbol] functioned as modifiers preceding an Organization entity, the pronouns are not to be tagged as part of Organization. [symbol] “I country Communist Party” [symbol] “we Tsinghua University”.
   5. Embassies and Consulates
   Names of embassies, consulates and other diplomatic missions should be marked as Organization only if both the country they represent and their location can be included in the markup.
[symbol] [symbol] “then transferred to U.S. stationed at Honduras embassy”.

If Embassy descriptor is contiguous with the country/district it represents, then the country/district is to be tagged as part of Organization.

[symbol] [symbol] “go to Honduras Embassy in Hong Kong” If Embassy descriptor is contiguous with the geography location, then mark any locations separately as Location, and do not tag the embassy as an Organization.

[L [symbol] [L [symbol] [symbol] “U.S. going through stationed at Kinshasa embassy and other normal channels”.

6. Manufacture and Product

In cases where the manufacture and the product are named, the manufacture is to be tagged as Organization, while the product is not to be tagged. Products must be defined loosely to include manufactured products (e.g. vehicles), as well as computed products (e.g., stock indexes) and media products (e.g., television shows).
[O [symbol] [symbol] [symbol] “Dow Jones industrial average index”.
   7. Do tag news sources (newspapers, radio and TV stations, and news journals) as Organization. Both publishers and publications are to be tagged as Organization. Note that TV stations differ from TV shows, the latter not being taggable.
[O [symbol] [symbol] “Peoples' daily overseas edition pay three”.
[symbol] [O [symbol] “this is central station reporting”.
   8. Organization-Like Non Taggable
   Generic entity names such as “the government”, are not to be tagged.
[L [symbol] “China government”
[L [symbol] “Xinjiang Autonomy district government” [O [symbol] [symbol] “China public safety department (s)”.

Do not mark the term [symbol] “center” by itself as an Organization. However, do mark [symbol] “party center” as an Organization.
[symbol] “under the leadership of the center”.
[symbol] [P [symbol] [symbol] [O [symbol] “party center, with comrade Jiang Zeming as its nucleus”. Do not tag [symbol] “exchange fair” as Organization.
[L [symbol] [L [symbol] [symbol] “China Tianjin exported commodity exchange fair”.
   9. Tag on several special named entities.
[L [symbol] “the Great Wall”
[O [symbol] “White House”
[O [symbol] “Kremlin says”

### How to Tag Timex

The TIME type is defined as a temporal unit shorter than a full day, such as “second, minute, or hour”. The DATE sub-type is a temporal unit of a full day or longer, such as “day, week, month, quarter, year(s), century, etc.” The DURATION sub-type captures durations of time.

1. Date

For the form string [symbol] duration, then entire phrase is tagged as dat_MET, because the duration is embedded in DAT so not to be tagged.

[dat_MET [symbol] “the first three days”
[dat [symbol] “autumn report”
[dat [symbol] “the fourth quarter”
[dat [symbol] “the fifteenth century”
[dat [symbol] “the spring Festival”
   Notes that the string [symbol] the first/second/last ten days of one month” are to be tagged [dat [symbol] “the last ten days of May” Words or phrases modifying the experssions, such as ‘around’ or ‘about’ are not be tagged. [symbol] date [symbol] “around May 4th”
   2. Time
[tim [symbol] “three to four o'clock in the morning”
[tim [symbol] “Beijing time 5 hour fifty nine minutes”
[tim_MET [symbol] , [tim_MET [symbol] , [tim_MET [symbol] , [tim_M [symbol] “morning, noon, afternoon, evening” Treatment of “ [symbol] about/around”
[tim [symbol] “in the evening about 7 hours arrive”
   In this phrase, the string ‘about’ is bounded by two Times and it is non-decomposable, so it is to be tagged.
[dat [symbol] [tim [symbol] “September 13^{th} about seven o'clock arrive in Beijing.
   In this phrase, the string [symbol] is bound by a date and a time, so it is decomposable.
   3. Duration
[dur 10)] “10 days”
[symbol] [dur [symbol] [symbol] “in the quarter century of discussions since the Watergate scandal . . . ”
   The string [symbol] is not to be included in Duration tag, because to include it or not makes little difference.
[symbol] [dur [symbol] “exactly fifteen years”
[dur [symbol] [symbol] “exactly at 9 o'clock arrive at Beijing station” [symbol] “nine years drought in ten years, i.e. often suffering drought”, no mark up on ‘nine’ and ‘ten’, because they are both virtual numbers in case.
   4. Non-Taggable:
   The time expressions that do not have absolute time scale, such as “just now, recently, since negotiation, a moment”, are not to be tagged.
   In the case that a festival expression does not have a absolute time, then it is not be tagged.
[L [symbol] “India international film festival”
[L [symbol] “Year of China Tourism, referring 1997”
[L [symbol] “U.S. Independence Day”, no markup for Independence Day because of its close connection with an event.

Do not tag the [symbol] “spring” in [symbol] “Spring couplets”.’

5. Special Case:

If two time expressions are in different sub-types, then they are to be tagged separately. If the two expression are non-decomposable, then they are to be tagged together.
[dat 2 [symbol] 12 [symbol] [tim [symbol] “Feb. 12 am 8 o'clock”
[dat [symbol] ][tim 8 [symbol] “Monday 8 o'clock”

If a location entity is embedded in time expression, the mark ‘MET’ is introduced to refer to the MET-2 guideline. “ER99” can be used to tag according to an alternative specification.
[tim [symbol] 199 [symbol] 2 [symbol] 9 [symbol] 19 [symbol] 28 [symbol] ]

The expressions such as “last year”, “yesterday”, “this morning” are to be tagged according to MET-2, call for annotators attention on the difference and use the extra mark accordingly.
[dat_MET [symbol] [dat_ER99 [symbol]
[dat_MET [symbol] [dat_ER99 [symbol]
[dat_MET [symbol] [dat_ER99 [symbol]
[dat_MET [symbol] [dat_ER99 4 [symbol] 17 [symbol] [tim_MET [symbol]
[dat_MET [symbol] [dat_ER99 [symbol]
[tim_MET [symbol] [tim_ER99 [symbol]
[dat_MET [symbol] [tim_MET [symbol]
[tim_MET [symbol] [tim_ER99 [symbol]
[tim [symbol]
[dat_MET [symbol] [tim_MET [symbol]
[dat_MET [symbol] [tim [symbol] 6 [symbol] 3 0 [symbol] ]
[symbol] [tim_MET [tim_ER99 [symbol] 1 1 [symbol] [tim_ER99
[symbol] 3 [symbol]
[tim_MET [symbol] [tim_MET

[symbol]

For the expression [symbol] this morning’, ER-99 treats it as a relative time entity and is not to be tagged, while in MET-2 the relative time is to be tagged.
[dur_ER99 [dat_MET [dat_ER99 11 [symbol] 2 4] [symbol]
[dat_ER99 2 7 [symbol]
[dat_MET [dat_ER99 11 [symbol] 2 4] [symbol] [dat_ER992 7 [symbol] [tim_MET [symbol]
[symbol] [tim_MET [symbol]
[tim_MET

[symbol]

For the expression [symbol] quite a few years”, ER-99 treat it as a fixed time duration and to be tagged, while [symbol] many years” is non-fixed duration and not be tagged.

The expression [symbol] one year” is to be tagged as Duration [symbol]
[symbol] [dur [symbol]
[symbol] [dur [symbol] [symbol] [symbol]
[symbol] [mon 900

[symbol]

The expression [symbol] each year”/ [symbol] annual, yearly”

[symbol]

[symbol]

[symbol]

### How to tag Numex

1. Percentage

[per [symbol] “thirty nine percent”
[symbol] [per 5%] “about five percent”
[per [symbol] “ninety percent”
   2. Money
[mon [symbol] “forty five thousand Yuan money”
[mon [symbol] “forty five thousand RMB”
[mon [symbol] [symbol] “RMB forty five thousand Yuan”
In the case that the same account money is spelled with different currencies, they are to be tagged separately. The location name embedded in Money is not to be tagged.
   [mon 43.6 [symbol] “43.6 billion USD”
The string “ [symbol] about” does not have an absolute concept, so it is not to be tagged.
   [symbol] [mon [symbol] “about one hundred thousand Yuan”
   [symbol] [mon $90,000] “more than $90000”
The string “ [symbol] several” can be changed by a certain number and to express an absolute account, so it is to be tagged.
   [mon [symbol] “several hundred thousand Yuan”
The string [symbol] over” is not to be tagged generally; in the following case it is tagged because the entire expression is non-decomposable.
   [mon [symbol] “twenty-seven hundred thousand over Yuan”
In this guideline, for a location name embedded in a currency, if is is spelled with abbreviation then it is not tagged, otherwise it is to be tagged as
   [mon 2000 [symbol] “2000 SID”
   [mon 2000 [L_ms [symbol] ‘2000 Sigapore Dollas Yuan’.
      3. Frequency/Integer/Fraction/Decima/Ordinal
[fre 26 [symbol]
[fre [symbol]
[fre [symbol]
[fra ¾]
[fra [symbol]
[fra [symbol]
[fra [symbol]
[fra [symbol]
[fra 4 [symbol]
[dec [symbol]
[ord [symbol]
[ord 1174 [symbol]
[ord 6 [symbol]
[ord [symbol]
[ord [symbol]
[int [symbol]
[int [symbol]
[int

[symbol]

If the integer/fraction/decimal has a number unit as a modifier, then the number unit is to be tagged.

[int [symbol] “several ‘jia’ factories” [symbol] [int 5 [symbol] “one family with five ‘kou’ persons” [int 58 [symbol] “58 times”.

4. Special case

The tab numbers are not be tagged. [symbol] [symbol] [symbol] [symbol]
   1. [symbol]
   2. [symbol]
   3. [symbol] [symbol]
   (1) [symbol] [symbol]
   (2) [symbol] [symbol] [symbol]
   (2) [symbol] [symbol] [symbol]
Numbers in some idioms, such as [symbol] one moment” [symbol] together”, [symbol] first level” [symbol] only one” etc, are not to be tagged.
Numbers embedded in Person name, Location name or Organization name are not to be tagged.
   [O [symbol] “No. 1 middle school”
   [L [symbol] “San Ming city”
   [symbol] [O 1205 [symbol]
If the string “-” functions as article ‘a’, then it is not be tagged. [symbol] one time over “is to be tagged. As a part of the ordinal number, “-” is to be tagged.
   [symbol] “a city”
[symbol] “one of the biggest companies”
[ord [symbol] the first prize”
[symbol] int [symbol] “my income is one time over his”.

### How to tag Measurex

MEASUREX includes: Age, Weight, Length, Temperature, Angle, Area, Capacity, Speed and Rate.
[age 34 [symbol]
[age [symbol]
[age [symbol]
[symbol] [wei [symbol]
[symbol] [len [symbol]
[symbol] [len [symbol] [len [symbol]
[symbol] [tem 2800 [symbol]
[symbol] [are 20 [symbol]
[symbol] [cap 34 [symbol]
[symbol] [cap [symbol]
—[cap [symbol]
[symbol] [spe 360 [symbol]
[wei [symbol]
[tem [symbol] [tem 6

[symbol]

Notes that: for the other units of weights and measures in Physics and Chemistry, they are to be tagged as “mea”
[mea 5.5 [symbol] “5.5 watt”
[mea 1.5 [symbol] “1.5 Newton”

### How to tag Addressx

ADDRESX includes: Email, Phone, Fax, Telex, WWW.
[ema exp@email.com.cn]
Tel: [pho 86-10-66665555]
[symbol] [pho 86-10-66665555]
FAX: [fax 86-10-66665555]
TELEX: [tel 86-10-66665555]
[www http:——www.hotmail.com]

For numbers of tel or fax, it is to be tagged only there is a designator such as “tel,

[symbol]

Although the present invention has been described with reference to particular embodiments, workers skilled in the art will recognize that changes may be made in form and detail without departing from the spirit and scope of the invention.

1. A corpus stored in a computer-readable medium for training a language model, the corpus comprising:
a plurality of characters; and
a plurality of morphological tags associated with a plurality of sequences of characters of the plurality of characters, the plurality of morphological tags indicating a morphological type of an associated sequence of characters and a combination of parts forming a morphological subtype.

2. The corpus of claim 1 wherein the morphological type is one of affixation, reduplication, split, merge and head particle.

3. The corpus of claim 1 wherein the morphological type is an affixation and the combination of parts includes a word and at least one of a prefix and a suffix.

4. The corpus of claim 3 wherein the combination of parts indicates a part of speech for the word.

5. The corpus of claim 1 wherein the morphological type is a reduplication and the combination of parts includes a pattern of characters.

6. The corpus of claim 1 wherein the morphological type is a merge and the combination of parts includes a pattern of characters.

7. The corpus of claim 1 and further comprising a plurality of factoid tags providing indications of whether a sequence of characters is a factoid.

8. The corpus of claim 1 and further comprising a plurality of named entity tags providing indications of whether a sequence of characters is a named entity.

9. The corpus of claim 1 and further comprising an indication of whether a sequence of characters is contained in a lexicon.

10. A computer readable medium having instructions for performing word segmentation, the instructions comprising:
receiving an input of unsegmented text;
accessing a language model to determine a segmentation of the text;
detecting a morphologically derived word in the text; and
providing an output of segmented text and an indication of a combination of parts that form the morphologically derived word.

11. The computer readable medium of claim 10 wherein the instructions further comprise indicating that the morphologically derived word is one of an affixation, reduplication, split, merge and head particle.

12. The computer readable medium of claim 11 wherein the instructions further comprise detecting a lexicon in the text.

13. The computer readable medium of claim 10 wherein the instructions further comprise detecting a factoid in the text.

14. The computer readable medium of claim 10 wherein the instructions further comprise detecting a named entity in the text.

15. The method of claim 10 wherein providing an output further comprises indicating a part of speech for the combination of parts.

16. The method of claim 10 wherein providing an output further comprises indicating a pattern of characters forming the combination of parts.

17. A method of developing a corpus for training a language model, comprising:
extracting a list of potential words from a corpus that match defined words and rules;
determining if the list includes a sufficient number of defined words and rules;
annotating the corpus to provide indications of word type; and
providing morphological tags in the corpus indicating a morphological type of an associated sequence of characters and a combination of parts forming a morphological subtype.

18. The method of claim 15 wherein annotating further comprises providing indications of whether the word is a lexicon, a morphologically derived word, a factoid and a named entity.

19. The method of claim 17 wherein the morphological type is one of affixation, reduplication split, merge and head particle.

20. The method of claim 17 wherein providing morphological tags further comprises indicating a part of speech for the combination of parts.

21. The method of claim 17 wherein providing morphological tags further comprises indicating a pattern of characters for the combination of parts.

22. The method of claim 17 and further comprising, after providing morphological tags in the corpus, using said corpus to annotate a larger amount of text.
